(19) United States
(12) Patent Application Publication
(10) Pub. No.: US 2007/0252300 A1
(43) Pub. Date: Nov. 1, 2007

(54) Novel aesthetics in surfaces

(76) Inventor: William Patrick Paplham, Getzville, NY (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/412,021

(22) Filed: Apr. 26, 2006

(51) Int. Cl. B29C 59/02

(52) U.S. Cl. 264/108; 264/293; 264/320; 264/331.18; 264/331.21

(57) ABSTRACT

Polymeric or polymerizable material with oriented decorative anisotropic particles is subjected to deformation that reorients the decorative particles. The result is an aesthetic patterned appearance.

### BACKGROUND OF THE INVENTION

1. Field of Invention

This invention relates to a process for producing a decorative surfacing material by selective orientation of decorative fillers.

2. Description of the Related Art

The preferred use for the process of this invention is the production of a decorative solid surface material. As employed herein, a solid surface material is understood in its normal meaning and represents a uniform, non-gel coated, non-porous, three dimensional solid material containing polymer resin and particulate filler, such material being particularly useful in the building trades for kitchen countertops, sinks, wall coverings, and furniture surfacing wherein both functionality and an attractive appearance are necessary. A well-known example of a solid surface material is Corian® produced by E. I. DuPont de Nemours and Company. A number of design aesthetics are heretofore known in solid surface materials, such as granite and marble, but they have a mostly two-dimensional appearance.

Most solid surface materials are manufactured by thermoset processes, such as sheet casting, cell casting, injection molding, or bulk molding. The decorative qualities of such products are greatly enhanced by incorporating pigments and colored particles such that the composite resembles natural stone. The range of patterns commercially available are constrained by the intermediates and processes currently used in the manufacturing of such materials.

Solid surface materials in their various applications serve both functional and decorative purposes. The incorporation of various attractive and/or unique decorative patterns into solid surface materials enhances its utility. Such patterns constitute intrinsically useful properties, which differentiate one product from another. The same principle applies to naturally occurring materials such as wood, marble, and granite whose utility, for example in furniture construction, is enhanced by certain naturally occurring patterns, e.g., grain, color variations, veins, strata, inclusions, and others. Commercially manufactured solid surface materials often incorporate decorative patterns intended to imitate or resemble naturally occurring patterns in granite or marble. However, due to limitations of feasibility and/or practicality, certain decorative patterns and/or categories of decorative patterns have not previously been incorporated in solid surface materials.

Decorative patterns that have been previously achieved in traditional solid surface manufacturing typically employ one of three methods:
(i) Monochromatic or polychromatic pieces of a pre-existing solid surface product are mechanically ground to produce irregularly shaped macroscopic particles, which are then combined with other ingredients in an uncured solid surface casting composition. Commonly employed macroscopic decorative particles known to the industry as “crunchies” are various filled and unfilled, pigmented or dyed, insoluble or crosslinked chips of polymers. Curing the casting composition during casting or molding produces a solid surface material in which colored inclusions of irregular shapes and sizes are surrounded by, and embedded in a continuous matrix of different color.
(ii) Casting a first and second curable compositions wherein the second composition is of a different color than the first composition, and is added in such a way that the two only intermix to a limited degree. In the resulting solid surface material, the different colored domains have smooth shapes and are separated by regions with continuous color variation.
(iii) Fabricating different colored solid surface products by cutting or machining into various shapes, which are then joined by means of adhesive to create multi-colored inlayed patterns or designs.

Using these traditional methods, it is required to mix materials of different colors or appearances to form decorative patterns. They do not produce certain categories of decorative patterns not dependent on combinations of different colors.

A new class of aesthetic for solid surface materials is disclosed in U.S. Pat. No. 6,702,967 to Overholt et al. which discloses a process for making a decorative surfacing material having a pattern by preparing a curable composition with orientable anisotropic particles, forming numerous fragments of the composition, and reforming the fragments into a cohesive mass with at least some of the fragments having the oriented particles in different orientations.

### SUMMARY OF THE INVENTION

The invention is a process for forming a decorative pattern in a surface of a solid surface material containing anisotropic particles comprising the steps of orienting at least a majority of the anisotropic particle in a flowable solid surface material, indenting a plurality of surface areas in the flowable solid surface material to disrupt the orientation of the anisotropic particle at indented surface areas, smoothing the surface of the flowable solid surface material having indented surface areas, and solidifying the flowable solid surface material.

### DRAWINGS

These and other features, aspects and advantages of the present invention will become better understood with reference to the following description, append claims, and accompanying drawings where

FIG. 1 is cross-section of a sheet of material with oriented anisotropic particulate filler.

FIG. 2 is a cross-section of a sheet of material with regions of reoriented anisotropic particulate filler.

FIG. 3 is a cross-section of a sheet of material with regions of reoriented anisotropic particulate filler with surface indentations.

FIG. 4 is a schematic of an optional embodiment of flattened surface indentations.

### DETAILED DESCRIPTION OF THE PREFERRED EMBODIMENTS

The present invention is a process for forming a decorative pattern in solid surface materials with anisotropic particles by orienting the anisotropic particulate filler. The anisotropic particulate filler in an uncured solid surface composition may be oriented by various means wherein at least some of the orientable particles are in a common orientation and subsequently reorienting, by various means, at least some of the oriented anisotropic particles (i.e., flakes) in specific regions to form a decorative pattern in solid surface materials. Another embodiment of the invention comprises a generally unoriented filler in the uncured solid surface composition and subsequently orienting, by various means, at least some of the oriented anisotropic particles (i.e., flakes) in specific regions to form a decorative pattern. The pattern is created by differences in anisotropic particle orientation between adjacent regions within the solid surface material. The process will create an aesthetic three-dimensional appearance in the solid surface material by the way ambient light differentially interacts with the adjacent regions due to particle orientation.

Solid surface compositions useful in the present invention are not specifically limited as long as they are flowable under process conditions and can be formed into a solid surface material. The polymerizable composition may be a casting sirup as disclosed in U.S. Pat. No. 3,474,081 to Bosworth, and cast on a moving belt as disclosed in U.S. Pat. No. 3,528,131 to Duggins. In another embodiment of the invention, the polymerizable compositions may be made by a process in which compression molding thermosettable formulations are made and processed as described in Weberg et al., in U.S. Pat. No. 6,203,911 and the compression molding compound is put through an extrusion process step. Solid surface formulations could also include various thermoplastic resins capable of compression molding. In a further embodiment of the invention, the polymerizable composition may be made and extruded according to the disclosure of Beauchemin et al. in U.S. Pat. No. 6,476,111. In all embodiments, orientable anisotropic aesthetic-enhancement particles are included in the polymerizable compositions, as described hereinafter. Anisotropic pigments, reflective particles, fibers, films, and finely divided solids (or dyes) may be used as the aesthetic-enhancement particles to highlight orientation effects. By controlling the amount of enhancement particles, and the shape and size of the reoriented regions, the translucency of the resulting solid surface material can be manipulated to give a desired aesthetic. Different colors, reflectivity, and translucency can be achieved by combining different amounts of enhancement particles, fillers, and colorants, and the degree to which the anisotropic filler particles are reoriented.

Anisotropic particulate fillers useful in the present invention are not specifically limited as long as they have an aspect ratio that is sufficiently high to promote particle orientation during material processing and have an appearance that changes relative to the orientation to the material and the observer. Preferred anisotropic particulate fillers include materials that have an aspect ratio that is sufficiently high to promote particle orientation during material processing and have an appearance that changes relative to the orientation to the material and the observer. The aspect ratios of suitable enhancement particles cover a broad range, e.g. metallic flakes (20-100), mica (10-70), milled glass fiber (3-25), aramid fiber (100-500), chopped carbon fiber (800), chopped glass fiber (250-800) and milled coated carbon fiber (200-1600). These visual effects may be due to angle dependent reflectivity, angle dependent color absorption/reflection, or visible shape. These particles may be plate-like, fibers, or ribbons. The aspect ratio is the ratio of the greatest length of a particle to its thickness. Generally the aspect ratio will be at least 3, and more generally at least 20. Plate-like materials have two dimensions significantly larger than the third dimension. Examples of plate-like materials include, but are not limited to: mica, synthetic mica, glass flakes, metal flakes, alumina and silica substrates, polymer film flakes, as well as synthetic materials such as ultra-thin, multi-layer interference flakes (e.g., Chromaflair® from Flex Products), and helical superstructure, cigar-shaped liquid crystal molecules (e.g., Helicone® HC from Wacker). In many cases, the surfaces of the platy substrate are coated with various metal oxides or pigments to control color and light interference effects. Some materials appear to be different colors at different angles.

Fibers have one dimension that is significantly larger than the other two dimensions. Examples of fibers include, metal, polymer, carbon, glass, ceramic, and various natural fibers. Ribbons have one dimension that is significantly larger than the other two, but the second dimension is noticeably larger than the third. Examples of ribbons would include metals and polymer films.

Optionally, the polymeric compositions may include particulate or fibrous fillers that are either not isotropic or not aesthetic. In general, fillers increase the hardness, stiffness or strength of the final article relative to the pure polymer or combination of pure polymers. It will be understood, that in addition, the filler can provide other attributes to the final article. For example, it can provide other functional properties, such as flame retardation, or it may serve a decorative purpose and modify the aesthetic. Some representative fillers include alumina, alumina trihydrate (ATH), alumina monohydrate, aluminum hydroxide, aluminum oxide, aluminum sulfate, aluminum phosphate, aluminum silicate, Bayer hydrate, borosilicates, calcium sulfate, calcium silicate, calcium phosphate, calcium carbonate, calcium hydroxide, calcium oxide, apatite, glass bubbles, glass microspheres, glass fibers, glass beads, glass flakes, glass powder, glass spheres, barium carbonate, barium hydroxide, barium oxide, barium sulfate, barium phosphate, barium silicate, magnesium sulfate, magnesium silicate, magnesium phosphate, magnesium hydroxide, magnesium oxide, kaolin, montmorillonite, bentonite, pyrophyllite, mica, gypsum, silica (including sand), ceramic microspheres, ceramic particles, ceramic whiskers, powder talc, titanium dioxide, diatomaceous earth, wood flour, borax, or combinations thereof.

Furthermore, the fillers can be optionally coated with sizing agents, for example, silane (meth)acrylate which is commercially available from OSI Specialties (Friendly, W. Va.) as Silane 8 Methacrylate A-174. The filler is present in the form of small particles, with an average particle size in the range of from about 5-500 microns, and can be present in amounts of up to 65% by weight of the polymerizable composition.

The nature of the filler particles, in particular, the refractive index, has a pronounced effect on the aesthetics of the final article. When the refractive index of the filler is closely matched to that of the polymerizable component, the resulting final article has a translucent appearance. As the refractive index deviates from that of the polymerizable component, the resulting appearance is more opaque. ATH is often a preferred filler for poly(methylmethacrylate) (PMMA) systems because the index of refraction of ATH is close to that of PMMA. Of particular interest are fillers with particle size between 10 microns and 100 microns. Alumina (Al₂O₃) improves resistance to marring. Fibers (e.g., glass, nylon, aramid and carbon fibers) improve mechanical properties. Examples of some functional fillers are antioxidants (such as ternary or aromatic amines, Irganox® (Octadecyl 3,5-Di-(tert)-butyl-4-hydroxyhydrocinnamate) supplied by Ciba Specialty Chemicals Corp., and sodium hypophosphites, flame retardants (such as halogenated hydrocarbons, mineral carbonates, hydrated minerals, and antimony oxide), UV stabilizers (such as Tinuvin® supplied by Ciba Geigy), stain-resistant agents such as Teflon®, stearic acid, and zinc stearate, or combinations thereof.

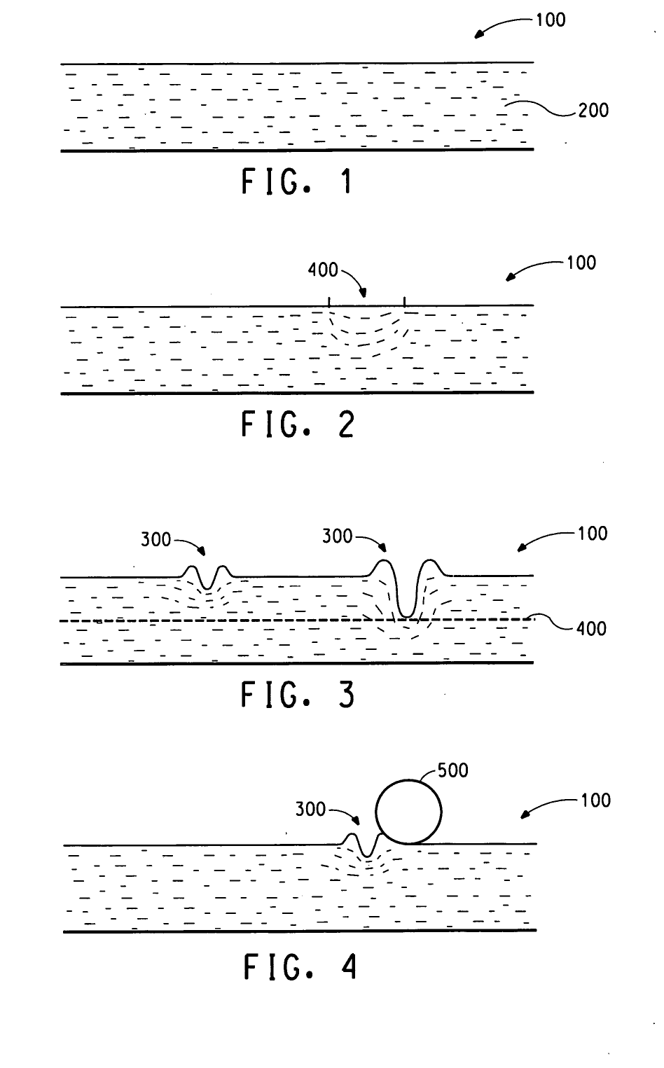

In carrying out the process of this invention, the orientation of the anisotropic particulate fillers may be done by taking advantage of the tendency of the particles to align themselves during laminar flow of the polymerizable matrix, as shown schematically in FIG. 1 wherein the oriented anisotropic particles (200) are shown generally parallel to the surface of a sheet (100). The laminar flow may be created by a number of process methods, depending on the Theological nature of the polymerizable composition. Flowable compositions may have the anisotropic particulate fillers oriented by casting on a moving belt, with optional employment of a doctor blade. Extrudable uncured solid surface molding compositions may employ extrusion through a die plate, with no limitations on the die geometry. Calender rolls may be used as the primary means of anisotropic particulate filler orientation, or added as an additional. The additional calendering step may be for the purpose of orienting the anisotropic particulate filler or may be for any other purpose, such as gauging the thickness of the material or adding a texture to the surface. In general at least 70% of the anisotropic particles, and more generally, at least 90% have the same orientation.

An aesthetic is created in the uncured solid surface composition by selective reorientation of the anisotropic particles. The reoriented particles do not have the same orientation as the bulk of the material after selective reorientation, which results in the region of the reorientation (400) appearing visually different as shown in FIG. 2. The actual method of selected reorientation can vary depending on the nature of the uncured solid surface composition and the desired aesthetic. In an embodiment of the invention, the reorientation is caused by physical deformation of the material. Methods of deforming the material to reorient the particles include manual indentation with physical objects, such as screwdrivers, seashells, knives, roller, coins, etc. Automated processing methods may include patterned rolls, presses, etc. The method of deformation need not be physical objects, depending on the nature of the material to be deformed, air or fluid jets might also be used. In low viscosity systems, a denser fluid may be used to create a pattern. As the denser fluid sinks in the matrix, the material flow reorients the anisotropic decorative particulate fillers, creating the desired aesthetic.

Some embodiments of reorienting the anisotropic particles will form indentations (300) in the surface of the polymerizable composition as shown in FIG. 3. The indentations may be useful in some aesthetic designs, but in general it is found that a flat surface is preferable. This may be achieved by material removal (i.e. sanding) to a level (400) below the deepest indentation after the polymerizable composition is cured into a sheet. An optional processing step that flattens the sheet without material removal before curing is desirable. This often causes a portion of the reoriented regions to reorient in the direction of the bulk composition but they don't tend to completely return to their original orientation. In low viscosity systems, the material may self level by gravity induced material flow. One preferred embodiment of flattening in higher viscosity systems is shown in FIG. 4 wherein a calender roll (500) is used to flatten the surface. The calender roll may optionally be used to form a texture on the surface.

After any surface flattening or texturing, the uncured composition is solidified. Solidifying of the polymerizable composition after the reorientation of the anisotropic particles is done according to what polymer system is used. Most solid surface materials manufactured by thermoset processes, such as sheet casting, cell casting, injection molding, or bulk molding will use cure agents that when thermally activated will generate free radicals which then initiate the desired polymerization reactions. Either a chemically-activated thermal initiation or a purely temperature-driven thermal initiation to cure the acrylic polymerizable fraction may be employed herein. Both cure systems are well known in the art. Solidifying of thermoplastic embodiments of the invention, such as extruded thermoplastics, is accomplished by allowing the composition to cool below the glass transition temperature.

The following examples are included as representative of the embodiments of the present invention. The percentages are by weight, and the temperatures are in centigrade, unless otherwise noted.

### EXAMPLES

### Example 1

The following ingredients are weighed:
1120 gm alumina trihydrate (ATH)
401 gm Paraloid® Latex K120ND poly(methyl methacrylate/ethyl acrylate) polymer particle setting agent (from Rohm & Haas)
6 gm Zinc Stearate
40 gm Afflair® 500 Bronze Mica
361 gm methyl methacrylate (MMA)
57.8 gm ethylene glycol dimethacrylate (EGDMA)
6.92 gm Luperox® 575 (t-Amyl peroxy-2-ethyl hexanoate) thermal initiator (from Atofina)
1.13 gm Vazo® 67, 2,2′-azobis(methylbutyronitrile) thermal initiator (from DuPont)
1.68 gm Zelec® MO coupling agent (from DuPont)
4 gm pigment dispersion
   Liquid Premix

Prepare a liquid premix by combining the MMA, EGDMA, and Zelec® MO in a small vessel and mixing them with an impeller for 2 minutes to mix them evenly. The Luperox® 575 and Vazo® 67 are then added and mixed for 10 minutes to mix fully and ensure the Vazo® 67 is fully dissolved.

Dry Blending

A mixture of the solids is then prepared by dry blending the ATH, Paraloid®, and Zinc Stearate in a Double Planetary Mixer equipped with high viscosity mixing blades. The ingredients are blended for 5 minutes after which 40 grams of Afflair® 500 Bronze mica is added to the mixed solids.

Mixing

4 grams of red iron oxide pigment dispersion are added to the ingredients of the Double Planetary Mixer (DPM). The liquids from the Liquid Premix are then added to the mixture and blended for 6 minutes beyond the point where the ingredients coalesce into a cohesive formulation. The cohesive mass is then removed from the mixer and sealed in a container, which is impervious to MMA and allowed to rest for a minimum of one hour to allow additional adsorption of the MMA into the Paraloid® latex particles.

Orienting and Re-Orienting Particles

The rested mixture is added to an extruder. The molding compound is extruded through a sheet die, orienting the mica particles in a generally common orientation. Immediately after exiting the die, selective realignment of the anisotropic particles may be achieved by deforming the material by a variety of methods, including cutting, indentation, patterned molds, or rollers. The indentation is done by deformation by impacting the surface with one or more of a variety of objects including knives, screwdrivers, hammers, sticks, seashells, and rollers. The deformed sheet with reoriented anisotropic particles may then be passed through calendering rolls to flatten the sheet. The final step is to cure the molding compound.

### Example 2

The following ingredients were weighed:

| | |
|---|---|
| 2.331 kg | Nylon |
| 4.604 kg | poly(methylmethacrylate) |
| 0.163 kg | ethylene n-butyl acrylate glycidyl methacrylate |
| | (EBAGMA) |
| 1.040 kg | Epoxy |
| 0.074 kg | Nylon Stabilizer |
| 0.490 kg | poly(tetrafluoroethylene) (PTFE) |
| 3.638 kg | Fiberglass |
| 2.510 kg | BaSO4 |
| 0.150 kg | Gold Colored Mica |

These ingredients were compounded in an extruder and passed through a slot die. The extruded ribbon was deformed with various objects, including screwdriver, seashells, etc. The ribbon then passed through a calendering roll, which returned the ribbon to a flat sheet. Aesthetic patterns were visible at the point of the indentations. The formerly indented areas were darker when viewed normal to the sheet, but reflected light at other angles, indicating that the mica was no longer oriented in the plane of the sheet as compared to the undisturbed regions.

What is claimed is:

1. A process for forming a decorative pattern in a surface of a solid surface material containing anisotropic particles comprising the steps of:
(a) orienting at least a majority of the anisotropic particle in a flowable solid surface material,
(b) indenting a plurality of surface areas in the flowable solid surface material to disrupt the orientation of the anisotropic particle at indented surface areas,
(c) smoothing the surface of the flowable solid surface material having indented surface areas, and
(d) solidifying the flowable solid surface material.

2. The process of claim 1 wherein the solid surface material is comprised of acrylic resin.

3. The process of claim 1 wherein the solid surface material is comprised of polyester resin.

4. The process of claim 1 wherein the aspect ratio of the anisotropic particles have an aspect ration of at least 3.
